(19) United States
(12) Patent Application Publication
(10) Pub. No.: US 2015/0302754 A1
(43) Pub. Date: Oct. 22, 2015

(54) SYSTEMS AND METHODS FOR A SEARCH DRIVEN, VISUAL ATTENTION TASK FOR ENHANCING COGNITION

(71) Applicant: LUMOS LABS, INC., San Francisco, CA (US)

(72) Inventors: David Ethan KENNERLY, San Francisco, CA (US); Benjamin Lee AHRONI, San Francisco, CA (US); Aaron KALUSZKA, Hayward, CA (US)

(21) Appl. No.: 14/789,082

(22) Filed: Jul. 1, 2015

Related U.S. Application Data
(63) Continuation of application No. 14/500,612, filed on Sep. 29, 2014.
(60) Provisional application No. 61/885,918, filed on Oct. 2, 2013.

(51) Int. Cl. G09B 5/02

(52) U.S. Cl. CPC G09B 5/02

(57) ABSTRACT

A method and apparatus for enhancing a cognitive ability of a user is disclosed, which may comprise: conducting, via a user interface display of a user computing device, a training session which may comprise: presenting, via the user interface display of the user computing device, a plurality of objects having at least two identifying parameters, at least two of the plurality of objects having the same at least two identifying parameters forming at least one group of objects having the same at least two identifying parameters and at least one of the objects having at least one unique identifying parameter thereby not duplicating the identifying parameters of the at least two objects in the at least one group of objects; and allowing the user, via the user interface display of the user computing device, to select an object as a proposed unique object.

### CROSS-REFERENCE

This application is a continuation application of U.S. patent application Ser. No. 14/500,612 filed Sep. 29, 2014, which claims the benefit of Provisional Application No. 61/885,918, filed Oct. 2, 2013, entitled Systems and Methods for a Search Driven, Visual Attention Task for Enhancing Cognition, by David Ethan Kennerly, et al., which applications are incorporated herein by reference.

### INTRODUCTION

Attention represents the allocation of cognitive processing resources. Visual search refers to the attentional task that involves a scan of the visual environment to detect a particular object among a set of objects. Performing such tasks is useful in daily life in activities such as finding a product in the store, finding a friend in a crowd, in more specialized roles, such as performing quality control on an assembly line, and historically, finding food or avoiding predators in the natural environment. Enhancing an individual's attentional task capacity is highly desirable.

Many studies have shown that attentional abilities can be increased through repeated practice of a visual search task. See, CZERWINSKI, et al., Automatization and Training in Visual Search. The American Journal of Psychology 15(2) 271-315 (1992); HO, et al., Plasticity of Feature-Based Selection in Triple-Conjunction Search, Canadian Journal of Experimental Psychology 57(1) 48-60 (2003). These promising approaches demonstrate the appeal of visual search training, however, they are not without their limitations. In particular, research has shown that generalization of training of visual stimuli is related to the similarity of the stimuli. See, DUNCAN, et al., Visual Search and Stimulus Similarity, Psychological Review 96(3) 433-458 (1989); HO, et al., Age, Skill Transfer, and Conjunction Search. Journal of Gerontology 57B(3) 277-287 (2002). Thus, to be most effective, a visual search task should include primitive and varied visual stimuli. Furthermore, such tasks can be adapted in real-time to maximize challenge and efficacy to users.

Of particular difficulty are conjunction searches, searches in which the target object shares visual properties with distractor objects, such as color, shape, orientation, motion, and size. See, TREISMAN, et al., A feature-integration theory of attention. Cognitive Psychology 12 97-136 (1980); LOBLEY, et al., Perceptual learning in visual conjunction search, Perception 27 1245-1255 (1998). Conjunction search reduces stimulus-driven search and is thought to be driven by top-down processing, where perception is influenced by experience. Organic tasks involving visual search activate frontal eye field, superior colliculus, and multiple parietal areas in a robust and ecologically relevant manner. See, MULLER, et al., The functional neuroanatomy of visual conjunction search: a parametric fMRI study, Neurolmage 20, 1578-1590 (2003); DONNER, et al., Involvement of the human frontal eye field and multiple parietal areas in covert visual selection during conjunction search. European Journal of Neuroscience 12(9) 3407-3414 (2001).

What is needed are cognitive training exercises that train visual attentional abilities in an intuitive, engaging, and adaptively challenging way to enhance cognition.

### SUMMARY OF THE INVENTION

Disclosed are novel cognitive training exercises that train visual attentional abilities in an intuitive, engaging, and adaptively challenging way to enhance cognition and related skills. The exercises engage users in a task where the user identities a unique object out of a set of objects as quickly as possible. As users progress through sequential trials, difficulty can be modulated by selecting various visual attributes that will best challenge the user and/or increasing the number and variation of the different object and/or types within the set of objects.

A goal of the exercises can be to scan multiple objects having various distinguishing attributes for an object that has no duplicate. The exercises require that the user/player visually search through multiple objects and quickly find the unique object.

It will be understood by those skilled in the art that methods and apparatuses for enhancing a cognitive ability of a user are disclosed, which may comprise: conducting, via a user interface display of a user computing device, a training session which may comprise: presenting, via the user interface display of the user computing device, a plurality of objects having at least two identifying parameters, at least two of the plurality of objects having the same at least two identifying parameters forming at least one group of objects having the same at least two identifying parameters and at least one of the objects having at least one unique identifying parameter thereby not duplicating the identifying parameters of the at least two objects in the at least one group of objects; and allowing the user, via the user interface display of the user computing device, to select an object as a proposed unique object.

According to other aspects of the disclosed subject matter the at least one group of objects may comprise a plurality of groups of objects and the at least one unique object may comprise one unique object. Additionally, the computing device may be configured to record whether the user successfully selected the at least one unique object as the proposed unique object. Other aspects may include, e.g., that each of the objects in the at least one group of objects may be identifiable as a member of the group by the combination of the at least two parameters selected from the group comprising: shape, size, color, texture, orientation, rotation direction and spin direction. Similarly the unique object may be identifiable as different from any member of the at least one group of objects by at least one of a parameter selected from the group comprising: shape, size, color, texture, orientation, rotation direction and spin direction.

Further aspects of the disclosed subject matter may include a complexity of training sessions wherein the complexity may be determined by the user computing device from at least one of a number of unique objects, a number of parameters per object in a group and a number of groups of objects. Aspects of the method and apparatus of the disclosed subject matter may also include enhancing the effectiveness of the cognitive training by requiring the user to complete training sessions of increasing complexity. Also, the complexity of the training sessions may increase or decrease according to a user performance during the current training session or a prior training session.

According to still other aspects of the disclosed subject matter a computer readable medium is disclosed which stores software that, when executed by a computing device, causes the computing device to perform methods which may comprise: operating a user interface display of a user computing device to conduct a training session which in turn may comprise: presenting a plurality of objects having at least two identifying parameters, at least two of the plurality of objects having the same at least two identifying parameters forming at least one group of objects having the same at least two identifying parameters and at least one of the objects having at least one unique identifying parameter thereby not duplicating the identifying parameters of the at least two objects in the at least one group of objects; and allowing the user to select an object as a proposed unique object.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a screen shot illustrating a trial where a set of objects are presented, wherein one object has a unique shape and/or color;

FIG. 2 is a screen shot the selection by a user of a unique object from the objects presented along with an indicator (such as a V) indicating a correct response has been chosen by the user;

FIGS. 3A-B are screen shots showing, respectively, a duplicate object that was incorrectly selected, and an indicator showing what the correct unique object selection response would have been;

FIG. 4 is a screen shot illustrating supplementary animation designates with fast response times and an indicator of a correct response;

FIG. 5 illustrates a game flow;

FIG. 6 illustrates a tutorial flow;

FIGS. 7A-C are screen shots that illustrate a method of interaction through a series of instructions and prompts;

FIG. 8 illustrates a screen shot providing interactive feedback, such as that presented during a tutorial session;

FIG. 9 illustrates a screen shot providing information presented at the end of a tutorial session;

FIG. 10 illustrates a flow which enables adapting difficulty as a user engages the program, as well as providing feedback;

FIG. 11 illustrates a screen shot showing a measure of progress which is indicated visually;

FIG. 12 illustrates a screen shot showing a final result screen containing a user's score, correct/total ratio and next session level; and

FIG. 13 illustrates a process flow directing players to play the tutorial and set game difficulty.

### DETAILED DESCRIPTION OF THE INVENTION

A gameplay disclosed herein enables a user to view multiple objects and make a selection of one of the objects based on the selected object's uniqueness relative to one or more groups of other objects displayed. In an aspect of the disclosure, as illustrated herein, a suitable object is an abstract shape with one or more distinguishing features. For example, where three objects are presented, two objects are configurable such that the objects have the same characteristics, while the third object is configurable so that it may have some overlapping characteristics but has at least one characteristic that is not shared with the group formed from the first two objects. Objects presented can include a plurality of objects in one or more groups where each group of objects shares overlapping characteristics.

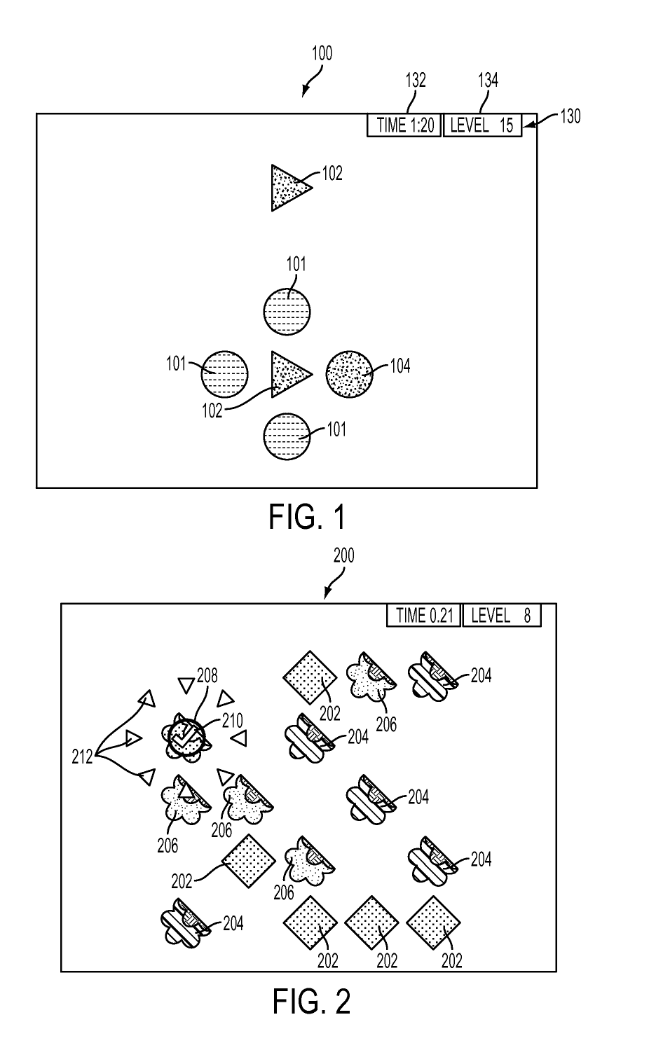

In one implementation, as illustrated in FIG. 1, for example, a plurality of objects 101, 102, 104 are presented to a user on a screen display 100. The objects 101, 102, 104 may be presented in an orthogonal grid pattern on the screen. However, as will be appreciated by those skilled in the art, the layout is not limited to a grid and other layouts could be employed without departing from the scope of the disclosure.

The user can select an object from objects 101, 102, 104 using a variety of mechanisms. For example, the object could be selected by pointing a curser and clicking a mouse on the desired location, or by using other pointing devices in a two dimensional (2D) or three dimensional (3D) space, or by touching the location desired on a touch-sensitive input device.

Each object can be represented by a shape, for example, a stylized asteroid in space. By way of example objects 101 can be represented as circles of a first color and objects 102 can be represented as triangles of the first color or a second color (in FIG. 1 shown as a second color). Objects of a first group would include, for example, circular objects of a first color 101, while objects of a second group would include triangular objects of a second color 102. A unique object 104 may be, as an example, represented by a circle (i.e., the shape from the group of first objects) of a second color (i.e., the color of the second group). Thus, in this instance, unique object 104 shares one characteristic with objects in the first group and one characteristic with objects in the second group but does not share all characteristics of any of the objects of either group. Objects may include other physical representations, such as faces in a crowd, automobiles, buildings, or people.

A status bar 130 may be provided on the screen display 100 which provides feedback on an elapsed time 132 and a difficulty level 134.

Turning now to FIG. 2, a plurality of objects 202, 204, 206, 208 is presented to the user on the screen display 200. After an object of the plurality of objects 202, 204, 206, 208 is selected on the screen display 200, feedback is provided to the user. Suitable feedback can include, for example, a circle of triangles 212 encircling the correct answer, thus confirming that the selected object was the unique object 208. As illustrated in FIG. 2 the objects may include, e.g., squares or diamonds 202 with a color and a dotted line texture pattern, flower blossom shapes with a solid line texture pattern 204, flower blossom shapes with a color and no texture pattern 206, and a unique flower blossom shape 208, with a dotted line texture pattern, all of the same color. The screen display 200 in FIG. 2 indicates feedback to the user in the form of the correct selection identifier indicator triangles 212 and/or a checkmark 210.

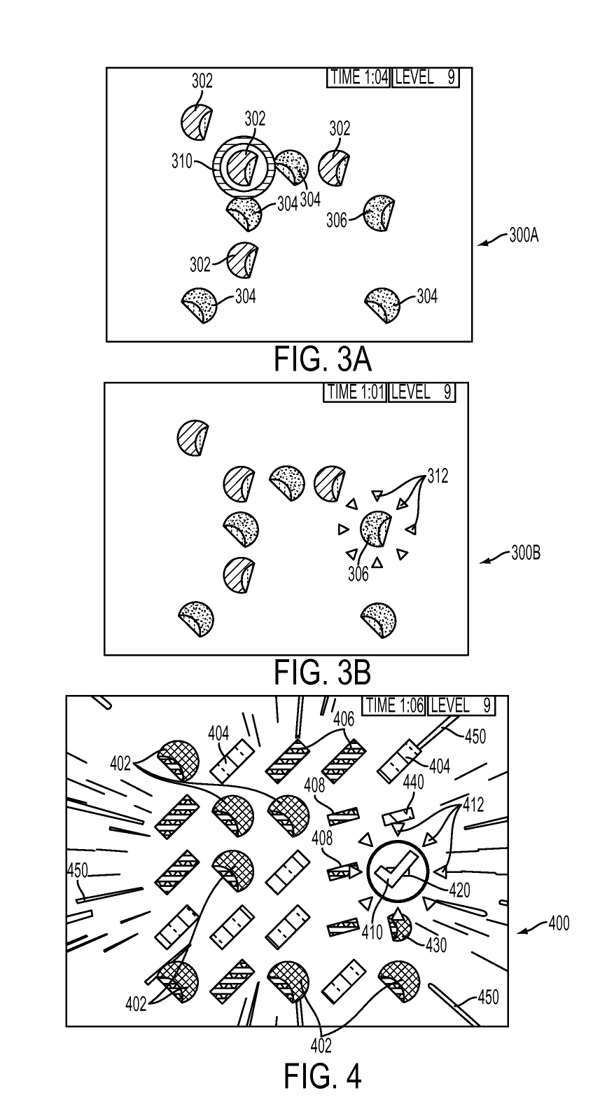

Feedback to the user of whether the selected object was a duplicate of other objects on the screen and which object is unique is further illustrated, by way of example, in FIGS. 3A-B. In the screen display 300A of FIG. 3A, e.g., a first group of shapes comprising a crescent moon shape 302 with a solid line texture pattern and oriented in a first direction can be included with a second group of shapes comprising a crescent moon shape with no texture pattern 304 oriented in a second direction, all of the same color, while a unique object, a crescent moon shape with no texture pattern 306, and of the same color, but oriented in a different direction than the similar shapes 304 are displayed on the screen display 300A. Assuming the user selected the shape 304 enclosed by the circle 310, the user would be informed of an incorrect selection, e.g. by the circle 310 around the selection. Other indications of an incorrect selection can also be used without departing from the scope of the disclosure, such as an international “no” symbol.

As illustrated, for example, in FIG. 3B, a plurality of objects are displayed on the display device 300B. The correct unique object selection of a crescent moon shape 306, of the same color and texture as the shapes 304, but oriented in a different direction, can be indicated by the correct selection indicator circle of triangles 312. In some configurations, if no response is given within a target amount of time (such as a few seconds), then an animated hint can be presented on the screen which draws the user's attention to the unique object.

After an object is selected, feedback may be given. For example, if the response was correct, as indicated above, then the correct response is confirmed. If the response was incorrect, then feedback may be provided. One or more additional opportunities may be provided to select a correct answer.

A suitable mechanism for illustrating a correct response as discussed above can be presented is shown in the screen display 400 of FIG. 4 by the circle of triangles 412 and the checkmark 410, respectively surrounding and covering the selected unique object 420. If the response was after a possible hint or was a duplicate object, e.g., one of the crescent shapes 402 then no such animation appears. In addition a suitable animation can be represented, as in FIG. 4, by “stars” 450 stretching, as if accelerating forward and briefly approaching the speed of light. Other physical representations, such as sliding objects to the left or right or textual indicators could be substituted. In FIG. 4, by way of another example, the shapes can be large bars 404 of a first color, and large bars 406 of a second color all in a first orientation, along with crescent moon shapes 402 all of a same color and orientation, and small bars 408 of the same color as the large bars 406 and having a given orientation. In the illustrated embodiment, perhaps to make the finding of a “unique” object easier, e.g., at a lower level of training, more than one unique shape(s) may be provided. For example, a small bar 440 of the same color as the large bars 404, and orientation as the small bars 408 of the different color, a small bar 420 shown under checkmark in circle of a different color and orientation from the small bars 408 and a small crescent moon shape 430 having the same color but a different orientation from the large crescent moon shapes 402. As indicated by the checkmark 410 in FIG. 4 the user has successfully selected one of the “unique” shapes, the oddly colored and oddly oriented small bar 420. It will be noted that objects 440 and 430 are also unique, i.e., a small bar of different color and a small crescent moon shape of different orientation, and for lower levels of play these extra selections may be available and selection of any one considered a correct selection.

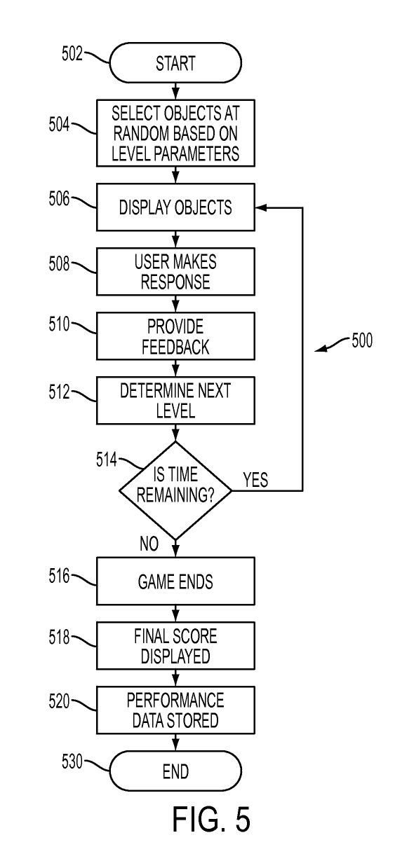

Multiple trials in a session may be presented to the user, each of which can display a new set of objects. A correct response also increases the score by a function of the difficulty of the trial. After a fixed duration of repeatedly answering these trials, the session of exercises can be ended as shown in the process flow diagram of FIG. 5. As explained in more detail elsewhere, results can be displayed to the user to indicate correct responses, the difficulty of the trials, and a user score that, e.g., may sum the count of correct user responses at each difficulty level or for each trial within a difficulty level.

Every set can be configurable to provide at least one unique object. Each object can further be configured to comprise several visual properties/parameters. Properties/parameters can include, for example, color, shape, texture, orientation, rotation, and spin. Other properties/parameters include, size, shading, skew, animation, and component makeup. The color of the subsets/groups of like objects and of the unique object can be randomly selected from a palette. Each color may also have a distinct combination of hue, saturation, and brightness that may also be distinct when viewed through a filter for common forms of color-blindness. The shape of the unique object can be randomly selected from a palette of distinct shapes. In some trials, the unique object may only be distinguishable by a unique texture that modulates the brightness of the surface of the object, such as by stripes, dots, and other patterns. In other implementations, other images could be superimposed on the object or overlap the silhouette of the object. In some trials, the unique object may be distinguished only by a unique rotation of the shape. Additionally, each rotation and shape combination(s) can be unique. In some trials, the unique object may be distinguishable by a clockwise or counterclockwise spinning animation. In these trials, e.g., to avoid ambiguity, each shape can further be configured to present a distinct image on each frame of animation in which it spins. In other implementations, the properties could be varied in a generative manner, rather than chosen from a fixed palette.

Besides the unique object, each sub-set/group also can contain a duplicate object(s) and areas in the visual field may contain no object. On most trials, there may be multiple varieties of duplicate objects. Typically, the attributes of a duplicate object differ from the unique object by at least one property. For example, a trial may have two shapes (square and circle) and two colors (red and blue). A unique object may be selected, such as a blue square, provided that there is a duplicates of the red square. If the trial has two varieties of duplicate objects, then one of the varieties may be comprised of duplicates of the same shape yet different color from the unique object, such as a red square, provided that none of the groups of squares are composed of red squares, and the other variety may be comprised of duplicates of the same color yet different shape as the unique object, provided that none of the groups are composed of blue circles.

Task difficulty can be moderated by a set of parameters, which may be increased to adapt to a user's skill, e.g., as illustrated by the process flow diagram of FIG. 5. In addition to these visual properties described above, difficulty may be also moderated by color palette, shape palette, duplicate variety, and the number of objects in the overall screen display and/or the individual sub-set/group and the number of sub-sets/groups. The similarity of hue, saturation and brightness in a palette can correlate to the response time to discern the unique color. The similarity of silhouette, brightness, and design in a shape within a palette can correlate to the response time to discern the unique shape. The variety of duplicates, as an example, can be utilized to increase the cognitive load of searching through the objects for an object with a unique combination of visual properties, and the number of objects to search through may also be utilized to increase the response time since all items in the sets/groups are scanned.

Turning now to a game play process flow diagram 500 of FIG. 5 a start block 502 can begin the process flow 500. The process may select objects at random based, e.g., on user performance level parameters, in block 504. The objects may be displayed on a display screen in block 506. The process flow can then receive a user response in block 508 and feedback may be provided in block 510, e.g., as to the correctness of the user provided response. The process flow may then determine a next level for the training of the user in block 512, e.g., based on exercise trials performed by the user to date. If, for example, there is time remaining in a current trial, e.g., as determined in decision block 514, the process flow can return to block 506 or otherwise the game can end in block 516. A final score can be displayed to the user in block 518 and user performance data may be stored in block 520, after which this portion 500 of the process flow for the method and apparatus of the disclosed subject matter can end in block 530.

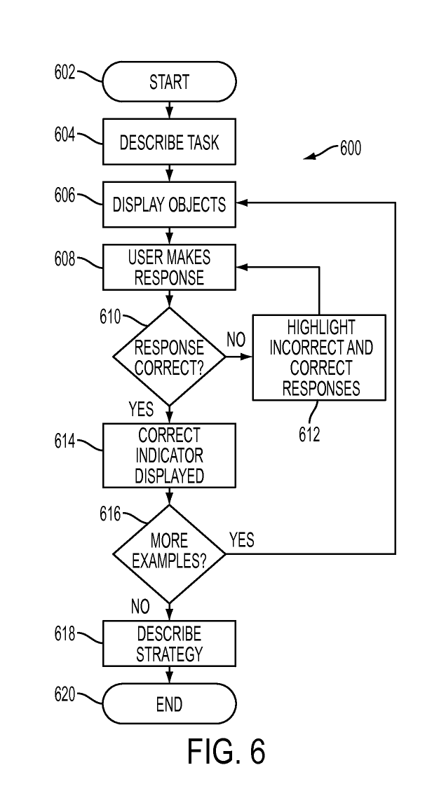

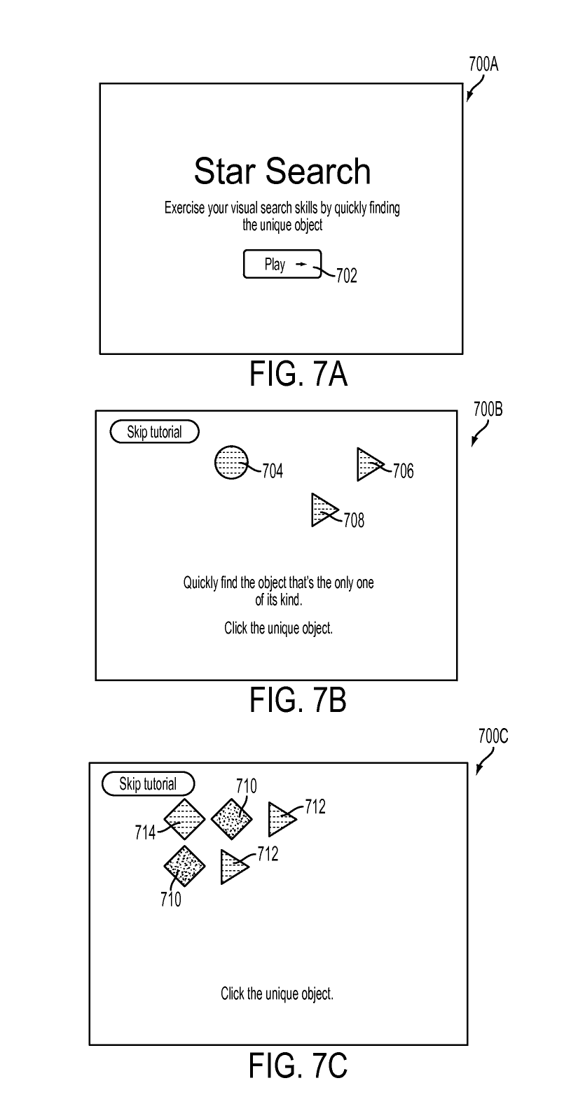

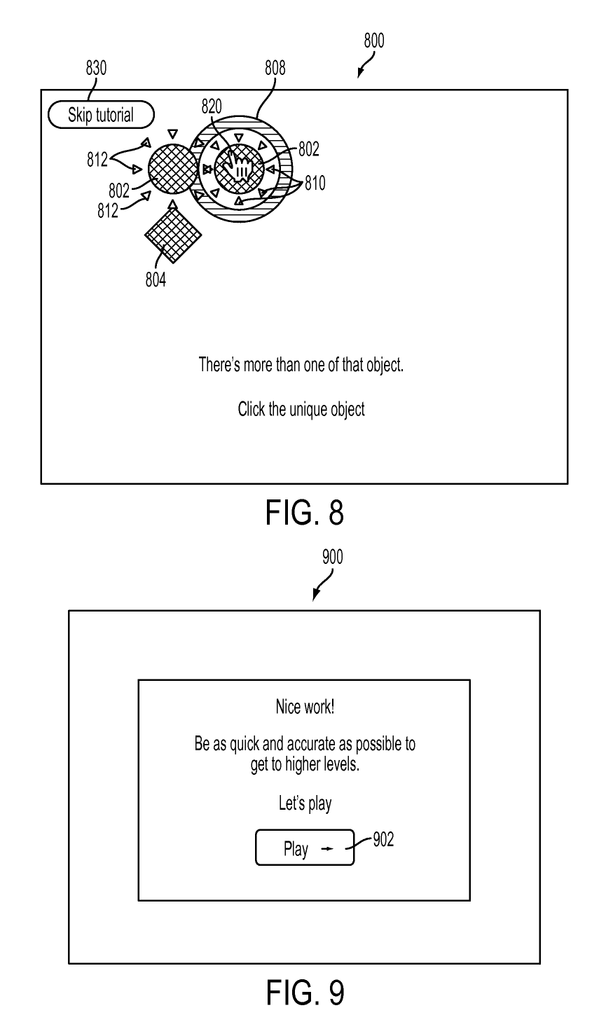

Turning now to FIG. 6 there is illustrated a tutorial process flow diagram 600. The process flow 600 can have a start block 602 followed by a describe task block 604 in which an object or objects of the game to be played can be explained to the user, utilizing screen displays, such as illustrated in FIGS. 7A-C. Objects may be displayed by a display objects block 606. When the user makes a response, by, for example, selecting a proposed unique object through a user GUI display, this may be determined in a “user makes response” block 608. Whether or not the user response correctly identifies the unique object, can be determined in a “response correct?” determination block 610. If the user response is determined to be incorrect then the system and method of the process flow can highlight correct and incorrect responses in block 612, as discussed in more detail with respect to FIG. 8. The process flow may then return either to block 608, as illustrated in FIG. 6, where a new user response is sensed or to block 606 (not illustrated) to display different objects for the tutorial. If the determination in block 610 is that the user response was correct, then a correct indicator can be displayed, for example, as indicated by checkmark 210 in FIG. 2, in a correct indicator displayed block 614. In a more examples determination block 616 the system and method of the process flow diagram 600 can determine if more examples are needed for the tutorial. Such a determination can be based, for example, on user performance in the tutorial. If more examples are warranted, then the system and method can return to block 606. If no additional examples are warranted, a strategy can be described to the user in a describe strategy block 618. Block 618 may be followed by an end block 620 where this part of the process flow comes to an end.

The user may be is introduced to the training exercise via a short interactive tutorial describing the gameplay elements, as illustrated in FIGS. 7A-C. An indication that the user is engaging in a tutorial can be evidenced by providing, for example, a “skip tutorial” button on the screen display. This allows the user to exit the tutorial at any time. FIG. 7A illustrates a screen display 700A. Screen display 700A can include a game name title “STAR SEARCH” and an explanation and instruction such as “Exercise your visual search skills by quickly finding the (or in some embodiments “a”) unique object.” Screen display 700A can also have a play button 702 which the user can click on to start the actual game play. Turning to FIG. 7B, screen display 700B can show a plurality of objects 704, 706, 708, such as a circle shaped object 704 and triangle shaped object 706 and triangle shaped object 708, all of the same color, i.e., with the triangle shaped objects 706, 708 forming a group, and the circle shaped object 704 being a unique object within the displayed objects. The screen display 700B can also include the instruction “Quickly find the object that is the only one of its kind,” and the instruction “Click on the unique object.” As shown in FIG. 7C, the screen display 700C can display a plurality of different objects 710, 712, 714, e.g., diamond shaped objects 710 of a first color and triangle shaped objects 712 of a second color along with a single unique diamond shaped object 714 of the second color. The screen display 700C can also have the instruction “Click on the unique object.”

As shown in FIG. 8, the tutorial is configurable to prompt the user to complete a series of simple game configurations with guided messages and prompts. Important gameplay features such as the unique object and the method of input to select an object can be explained with animations as illustrated in the screen display 800 of FIG. 8. Interactive feedback can inform the user of success in understanding the task, and players can be given a chance to retry after making an error, as is also illustrated by way of example in FIG. 8. As is illustrated in the screen display 800 of FIG. 8 a pair of circle shaped objects 802 of a given color can be displayed along with a unique diamond shaped object 804. A selection by the user of one of the circle shaped objects 802 can be indicated by a click on animation 820. The fact that this is an incorrect selection can be indicated by circling it with an incorrect response circle 808. The incorrect nature of the response may be indicated, e.g., by the caption “There is more than one of that object,” which may be further highlighted by object highlighter small triangles 810 around the selected circle shaped object 802 and object highlighter large triangles 812 around the matching other circle shaped object 802. The user can exit the tutorial by selecting the “Skip Tutorial” button 830 at any time.

As illustrated in the screen display 900 of FIG. 9, after a number of successful trials, the player is invited to start the game. The screen display 900 can include a caption such as “Nice work!” The screen display 900 can also include a further instruction such as “Be as quick and accurate as possible to get to higher levels.” Also included can be a caption such as “Let's play!” and a play button 902 that the user can select to been the actual game play. The tutorial may be recalled in the future, for example, the next time the user plays this particular game for the particular cognitive training afforded, if a player needs to be reminded how to play. The tutorial can also be dismissed if not needed by utilizing, for example, a “Skip Tutorial” button 830, as illustrated, e.g., in FIG. 8.

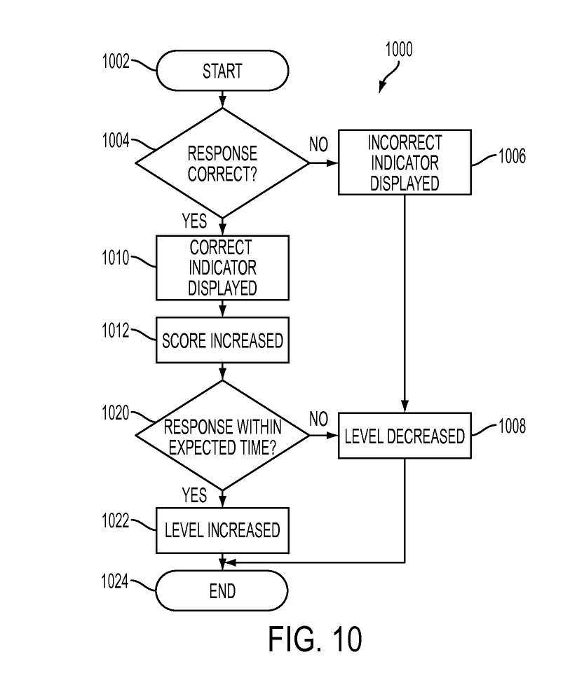

Turning now to FIG. 10 a level increasing process flow diagram 1000 is illustrated which can include a start block 1002, followed by a response correct? determination block 1004. If it is determined that the user response is not correct (NO), then in an incorrect indicator display block 1006, an incorrect response indicator, as discussed above, can be displayed. If the user response is determined to be a correct response, e.g., the correct response indicator discussed above can be displayed in correct indicator display block 1010. In a score increase block 1012 the user's score can be increased in a predetermined way for the correct response. Next it may be determined if the user's response was made within an expected time, e.g., according to the level the user is at, in determination block 1020. If either the user response was incorrect or not made within the expected time, then the process flow 1000 can decrease the level at which the user is performing in a level decrease block 1008. If the correct response was received within the expected time, then, in a level increase block 1022 the level at which the user is performing may be increased. The process flow diagram 1000 for this part of the overall process flow of the system and method of the disclosed subject matter may end at end block 1024. It will be understood that a given trial for a user may go through this block several times, e.g., depending on some selected time limit, a fixed number of times, a given level increase or decrease overall, etc.

To optimize training by ensuring that trial response times remain under an optimal or target time, an animation can be utilized to hint at what displayed object is the unique object. For example, after a set number of seconds, a highlighting circle of triangles 212 could be displayed on the screen around the unique object, e.g., the flower petal shape 208 such as is shown in FIG. 2. If the user selected the unique object before a hint is displayed, then the difficulty of the next trial can be increased. If the response selected by the user is a duplicate object or the unique object was selected after the hint was displayed, then the difficulty of the next trial can be decreased. The difficulty can be increased by, for example, increasing one of the parameters (e.g., total number of objects, groups, etc.) or by selecting a set of parameters that has been observed by the system and method of the disclosed subject matter in past trials of the user to correlate to a longer response time. The parameters at each level can be assigned and tuned through observations of a large sample of response times, such that each contiguous step can comprise a smooth curve of response times indicating a strong correlation between level of difficulty and correct response time value.

The current time remaining in the training session and level of difficulty currently achieved during the session can be displayed to the user in a display, e.g., as illustrated in FIG. 1, as a measure of progress. After a fixed time interval, by way of example, 75 seconds, which will be understood to be dynamically adjusted based on the user's performance, the user's session can be completed, and the user can be shown a results screen display 1200, as illustrated in FIG. 12, on which the score of the current session can be displayed along with other results related information. For example, the number of unique objects correctly selected out of a total number of objects and the level of difficulty achieved.

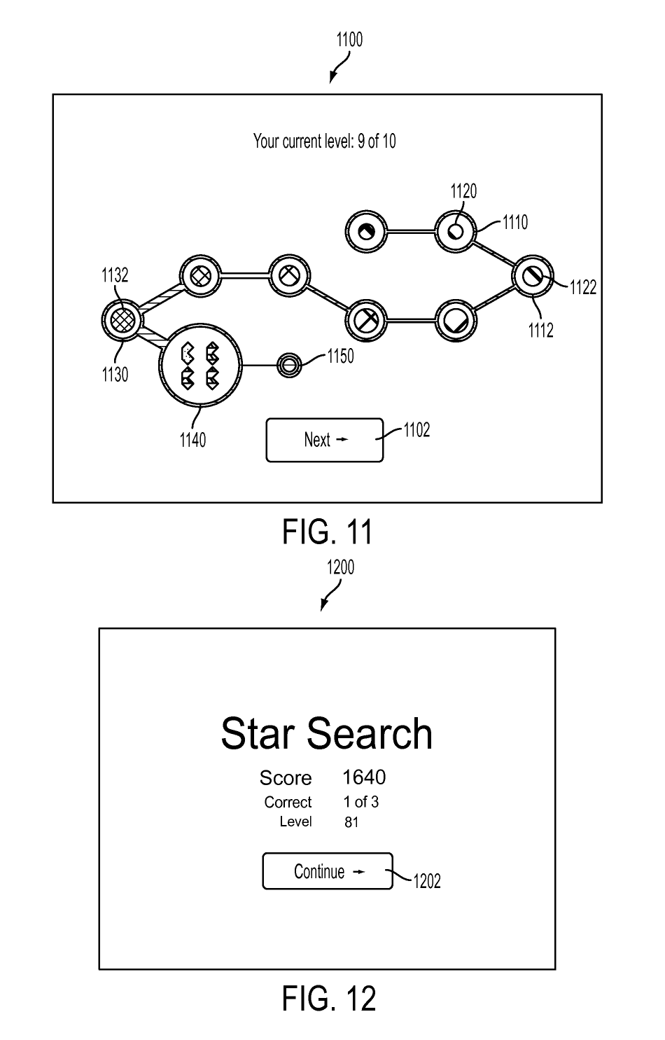

Before and/or after the main gameplay, the user can be presented with a track of progress, as illustrated by way of example in FIG. 11. Several milestones can be utilized to contextualize the level of difficulty achieved by the user to date out of a total range of difficulty. The level of difficulty for the next session may be, e.g., an average of the trial difficulties completed. Progress may be indicated by various indications of level achieved in each step of the training, e.g., with inner circles 1120, 1122 and 1132. For example, differing size and color shapes, surrounded by, for example outer circles 1110, 1112 and 1130. A current level could be indicated by a larger circle 1140. The current level indicator can also provide additional information such as an indication of the currently employed shapes and textural shadings.

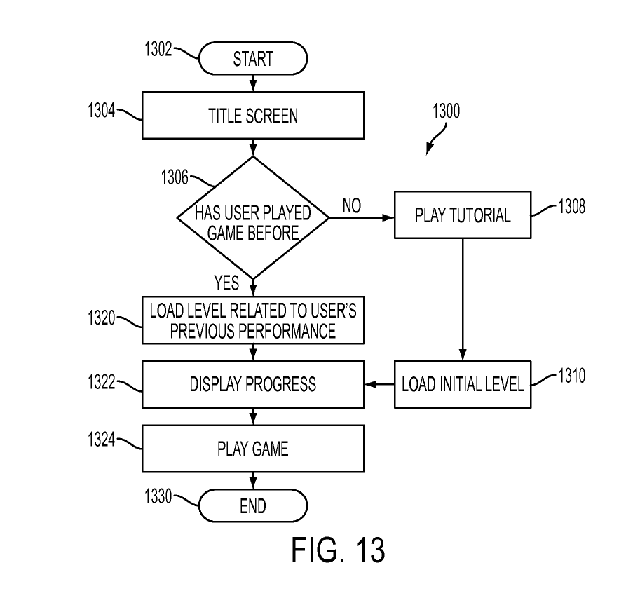

As illustrated in the process flow diagram of FIG. 13, the level of a user's progress can be displayed. For example, before gameplay, the user may optionally select a lower level of difficulty in order to improve performance at that level or to adjust to current performance conditions independent of best performance so far, such as the user's health and mood. Turning now to FIG. 13 there is illustrated by way of example a flow diagram 1300. The flow diagram 1300 may include a start block 1302, followed by a title screen display block 1304, in which the system and method according to aspects of the disclosed subject matter may display. For example, displays can include the title of the game, such as “STAR SEARCH.” In a determination block 1306, the system and method may determine if the particular user has played this particular game before and, if not, play a tutorial, as discussed above, in a play tutorial block 1308. After the tutorial, in block 1310, the system and method may load an initial game level in block 1320. In the load related level block 1320, if the user is determined to have played the game before, a level related to the user's previous performance(s) may be loaded by the system and method according to aspects of the disclosed subject matter. Following either block 1310 or 1320 user progress may be displayed in a display progress block 1322. The game may then be started in a play game block 1324. Finally an end block 1330 may cause this part of the process flow to stop.

The systems and methods according to aspects of the disclosed subject matter may utilize a variety of computer systems, communications devices, networks and/or digital/logic devices for operation. Each may in turn utilize a suitable computing device which can be manufactured with, loaded with and/or fetch from some storage device, and then execute, instructions that cause the computing device to perform a method according to aspects of the disclosed subject matter. A computing device can include without limitation a mobile user device such as a mobile phone, a smart phone and a cellular phone, a personal digital assistant (“PDA”), such as a BlackBerry, a tablet, a laptop and the like. In at least some configurations, a user can execute a browser application over a network, such as the Internet, to view and interact with digital content, such as screen displays. Access could be over or partially over other forms of computing and/or communications networks. A user may access a web-browser, e.g., to provide access to applications and data and other content located on a web-site or a web-page of a web-site.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method. The user's computing device may be part of a network of computing devices and the methods of the disclosed subject matter may be performed by different computing devices, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” shall include any and all of the above discussed logic circuitry, communications devices and digital processing capabilities or combinations of these.

Certain embodiments of the disclosed subject matter may be described for illustrative purposes as steps of a method which may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementations may involve the function, functionalities and operations noted in the blocks of a block diagram occurring out of the order noted in the block diagram, including occurring simultaneously or nearly so, or in another order or not occurring at all.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at some times be transitory, e.g., in transit from a remote storage device to a computing device over a communication link. However, when the machine readable medium is tangible and non-transitory, the instructions will be stored, for at least some period of time, in a memory storage device, such as a RAM, a ROM, a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of enhancing a cognitive ability of a user, comprising:
providing, via a user computing device interface display, a cognitive training session comprising:
displaying on the user interface display, via the user computing device, a plurality of objects wherein at least two of the plurality of objects form a first group of objects having at least two identifying parameters, and one object of the plurality of objects forms a second group having at least two identifying parameters wherein at least one of the two identifying parameters of the object within the second group is a unique identifying parameter;
receiving via a user interface input a selection from the user from the plurality of objects as a proposed unique object; and
providing, via the user interface display, an indicator that the user is correct or not correct.

2. The method of claim 1 wherein the plurality of objects forms one or more additional groups of objects wherein each of the additional groups of objects has two or more objects and each of the two or more objects within the one or more additional groups of objects has at least two identifying parameters and further wherein the at least two identifying parameters of the two or more objects of any of the one or more additional groups of objects has at least one parameter characteristic that is unique from one parameter characteristic of an object in another group.

3. The method of claim 1 further comprising:
recording, via a user computing device, whether the user successfully selected the at least one unique object as the proposed unique object.

4. The method of claim 2 wherein each of the objects in the at least one group of objects are identifiable as a member of the at least one group of objects by the combination of the at least two parameters selected from the group comprising: shape, size, color, texture, orientation, rotation direction and spin direction.

5. The method of claim 2 wherein the unique object is identifiable as different from any member of any the at least one group of objects by at least one of a parameter selected from the group comprising: shape, size, color, texture, orientation, rotation direction and spin direction.

6. The method of claim 1 wherein a complexity of the training session is determined by the user computing device from at least one of a number of unique objects, a number of parameters per object in a group and a number of groups of objects.

7. The method of claim 6 further comprising:
enhancing the effectiveness of the cognitive training by requiring the user to complete training sessions of increasing complexity.

8. The method of claim 7 further comprising:
increasing or decreasing, via the user computing device, the complexity of the training session according to user performance during the training session.

9. An apparatus for enhancing a cognitive ability of a user, comprising:
a user computing device, having a user interface display, configured to:
provide cognitive training comprising at least one trial comprising:
displaying on the user interface display, via the user computing device, a plurality of objects wherein at least two of the plurality of objects form a first group of objects having at least two identifying parameters, and one object of the plurality of objects forms a second group having at least two identifying parameters wherein at least one of the two identifying parameters of the object within the second group is a unique identifying parameter;
receiving via a user interface input a selection from the user from the plurality of objects as a proposed unique object; and
providing, via the user interface display, an indicator that the user is correct or not correct.

10. The apparatus of claim 9 wherein the at least one group of objects comprises a plurality of groups of objects.

11. The apparatus of claim 9 wherein the at least one unique object comprises one unique object.

12. The apparatus of claim 11 further comprising:
the user computing device further configured to record whether the user successfully selected the at least one unique object as the proposed unique object.

13. The apparatus of claim 11 wherein each of the objects in the at least one group of objects are identifiable as a member of the group by the combination of the at least two parameters selected from the group comprising: shape, size, color, texture, orientation, rotation direction and spin direction.

14. The apparatus of claim 11 wherein the unique object is identifiable as different from any member of the at least one group of objects by at least one of a parameter selected from the group comprising: shape, size, color, texture, orientation, rotation direction and spin direction.

15. The apparatus of claim 9 wherein the user computing device is further configured to determine the complexity of the training session from at least one of a number of unique objects, a number of parameters per object in a group, a number of groups of objects.

16. The apparatus of claim 15 wherein the user computing device is further configured to enhance the effectiveness of the cognitive training by requiring the user to complete training sessions of increasing complexity.

17. The apparatus of claim 16 wherein the user computing device is further configured to increase or decrease the complexity of the training session according to user performance during the training session.

18. A machine readable medium containing instructions that, when executed by a computing device, cause the computing device to perform a method, the method comprising:
providing cognitive training comprising at least one trial comprising:
displaying on the user interface display, via the user computing device, a plurality of objects wherein at least two of the plurality of objects form a first group of objects having at least two identifying parameters, and one object of the plurality of objects forms a second group having at least two identifying parameters wherein at least one of the two identifying parameters of the object within the second group is a unique identifying parameter;
receiving via a user interface input a selection from the user from the plurality of objects as a proposed unique object; and
providing, via the user interface display, an indicator that the user is correct or not correct.

19. The computer readable medium storing software of claim 18, wherein the method further comprising wherein the at least one group of objects comprises a plurality of groups of objects.

20. An apparatus for enhancing a cognitive ability of a user, comprising:
a user computing device means, having a user interface display means, configured to:
provide cognitive training comprising at least one trial comprising:
displaying on the user interface display means, via the user computing device means, a plurality of objects wherein at least two of the plurality of objects form a first group of objects having at least two identifying parameters, and one object of the plurality of objects forms a second group having at least two identifying parameters wherein at least one of the two identifying parameters of the object within the second group is a unique identifying parameter;
receiving via a user interface input means a selection from the user from the plurality of objects as a proposed unique object; and
providing, via the user interface display means, an indicator that the user is correct or not correct.

21. The apparatus of claim 20 wherein the at least one group of objects comprises a plurality of groups of objects.

22. The apparatus of claim 20 wherein the at least one unique object comprises one unique object.

23. The apparatus of claim 22 further comprising:
the user computing device means further configured to record whether the user successfully selected the at least one unique object as the proposed unique object.

24. The apparatus of claim 22 wherein each of the objects in the at least one group of objects are identifiable as a member of the group by the combination of the at least two parameters selected from the group comprising: shape, size, color, texture, orientation, rotation direction and spin direction.

25. The apparatus of claim 22 wherein the unique object is identifiable as different from any member of the at least one group of objects by at least one of a parameter selected from the group comprising: shape, size, color, texture, orientation, rotation direction and spin direction.

26. The apparatus of claim 20 wherein the user computing device means is further configured to determine the complexity of the training session from at least one of a number of unique objects, a number of parameters per object in a group, a number of groups of objects.

27. The apparatus of claim 26 wherein the user computing device means is further configured to enhance the effectiveness of the cognitive training by requiring the user to complete training sessions of increasing complexity.

28. The apparatus of claim 27 wherein the user computing device means is further configured to increase or decrease the complexity of the training session according to user performance during the training session.
